(19) United States
(12) Patent Application Publication
(10) Pub. No.: US 2006/0120007 A1
(43) Pub. Date: Jun. 8, 2006

(54) Apparatus for controlling interconnect switch

(75) Inventor: Raymond H. Legatti, Clearwater, FL (US)

Correspondence Address: Robert F. Frijouf, Esquire;Frijouf, Rust & Pyle, P.A., 201 East Davis Boulevard, Tampa, FL, 33606, US

(73) Assignee: Technology Research Corporation, Clearwater, FL (US)

(21) Appl. No.: 11/259,011

(22) Filed: Oct. 25, 2005

Related U.S. Application Data
(60) Provisional application No. 60/622,289, filed on Oct. 26, 2004.

(51) Int. Cl. H01H 47/00

(52) U.S. Cl. 361/160

(57) ABSTRACT

An apparatus is disclosed for controlling an interconnect switch connecting a power source to a load. The apparatus comprises an interconnect switch control circuit connected to the interconnect switch for closing the interconnect switch upon an application of voltage from the power source. A voltage storage circuit stores a voltage related to a nominal operating voltage of the power source. A comparator is connected to the voltage storage circuit for comparing an instantaneous voltage of the power source relative to a nominal operating voltage of the power source. A timing circuit is connected to the comparator and the interconnect switch control circuit for opening the interconnect switch for a selected period of time after a reduction of the voltage of the power source. The apparatus is suitable for disconnecting electrical power to the load after an interruption and/or reduction of voltage of the power source.

### CROSS-REFERENCE TO RELATED APPLICATIONS

This application claims benefit of U.S. Patent Provisional application Ser. No. 60/622,289 filed Oct. 26, 2004. All subject matter set forth in provisional application Ser. No. 60/622,289 is hereby incorporated by reference into the present application as if fully set forth herein.

### BACKGROUND OF THE INVENTION

1. Field of the Invention

This invention relates to electrical power and more particularly to an apparatus for disconnecting electrical power to a load after an interruption and/or reduction of voltage of a power source.

2. Background of the Invention

It is well-known in the art that many types of electrical machinery may be damaged by the rapid disconnection and reapplication of electrical power to the electrical equipment. One example of electrical machinery that may be damaged by the rapid disconnection and reapplication of electrical power is an air conditioning system. During the operation of the air conditioning system, the air conditioning compressor develops high internal fluid pressures. When an air conditioning compressor is deactivated, a several minutes are required for the high internal fluid pressure to reduce to a lower level suitable for restarting the air conditioning compressor. If the air conditioning compressor is restarted with a high internal fluid pressure within the air conditioning compressor, an excess current will flow through the electric motor rotating the air conditioning compressor.

Other types of electrical machinery may be damaged by the reduction of voltage to the electrical equipment. One example of electrical machinery that may be damaged by the reduction of voltage to the electrical equipment is an electric motor. During a reduction of voltage to the electric motor, the electric motor will continue to run with excessive current levels within the electric motor. The excess current levels within the electric motor may result in permanent damage and/or accelerated failure of the electric motor.

Various devices have been proposed in the prior art to reduce the damage to the electrical equipment by the rapid disconnection and reapplication of electrical power to the electrical equipment and/or the reduction of voltage to the electrical equipment. The following U.S. patents illustrate some of the attempts of the prior art to reduce the possibility of damage to electrical equipment due to rapid disconnection and reapplication of electrical power and/or the reduction of voltage to the electrical equipment.

U.S. Pat. No. 3,590,325 to J. W. McMillen discloses a circuit for sensing an undervoltage condition of a circuit breaker control power supply voltage. The circuit upon sensing the low voltage prevents the circuit breaker from being closed if it is open and opens the circuit breaker if it is closed and at the same time may actuate an alarm.

U.S. Pat. No. 3,619,668 to B. H. Pinckaers discloses an alternating current contactor or relay which can be used for control of equipment such as refrigeration compressors with a minimum off-time control. The minimum off-time control includes a resistor-capacitor timing circuit which charges initially from a power source through a transistor, and is held in a charged condition while the current continues to flow through the transistor to energize a sold-state switch which energizes the contactor. In the event that a momentary interruption of power occurs, or in the event that power is removed, the capacitor starts to slowly discharge activating a second transistor circuit that shorts out the first transistor so that the output switch cannot be reenergized for some minimum period of time.

U.S. Pat. No. 3,657,603 to W. M. Adams discloses a line voltage guard circuit having a network including neon lamps, resistor-capacitor timing branches, diodes and transistors. The network is connected to a switching relay to control the availability of the supply line voltage to apparatus utilizing the same and to disconnect the supply line from the apparatus when the line voltage is either below a bottom limit for a definite length of time or above a top limit. The circuit automatically reconnects the line to the apparatus at a predetermined time after the supply voltage returns to a value between the top and bottom limits.

U.S. Pat. No. 3,719,859 to R. J. Frantz et al. discloses a circuit to sense variations in alternating voltage applied to a load and to interrupt power flow to the load on reduction of the applied voltage. The circuit includes a rectifier to rectify the alternating voltage and a voltage regulator to apply a constant level. Part of the rectified voltage is supplied to a Schmitt trigger. Part of the rectified voltage controls conductivity of a transistor that provides the input signal to the Schmitt trigger according to variations in the rectified alternating applied voltage. A Zener diode references the Schmitt trigger at a voltage slightly below the voltage applied to the transistor controlling the trigger. A Zener diode is at the output of the trigger to control the presence or absence of signals from the Schmitt trigger to a further transistor that controls the gate of a triac connected in the power line to the load. The triac is gated to a non-conductive state to block power flow to the load upon reduced alternating applied power. The circuit also can be used to sense variations in direct current voltage applied to a load and to interrupt power flow to the load on reduction of the applied voltage, in which circumstance no rectifier is used and the direct current applied voltage is utilized in the same manner as the rectified voltage when alternating voltage variations are being sensed.

U.S. Pat. No. 3,784,846 to J. B. Krick et al. discloses a combination solid state voltage sensing and timing relay employed for disconnecting equipment from a line source when the line voltage drops below a preset voltage for a preset time period. The pick up voltage of the voltage sensor is fixed at a first level. The drop out voltage is adjustable by means of a variable resistance element to be at a value lying within a range that is just slightly below the pick up voltage at the top of the range to a value which is significantly below the pick up voltage. The time delay interval is adjustable by way of a second variable resistance over a range of the order from 0.5 to 10 seconds. The output of the undervoltage timer is a single pole normally open solid state switch for selectively connecting or disconnecting the line source form the load, depending upon the condition from the source and the length of time during which this condition persists.

U.S. Pat. No. 3,814,991 to W. L. Hewitt discloses a circuit for controlling a load, such as the cooling compressor of an air conditioner. The circuit prevents short cycling by utilizing a time delay or interlock after deenergizing a load and before the load can again be energized. The circuit is an all solid state circuit operable on initial control switch closure to turn on power to the load and charge the capacitor of a time delay circuit. The circuit is also operable on control switch opening to turn off power and maintain power off despite subsequent control switch closure until the capacitor has discharged through the delay circuit.

U.S. Pat. No. 3,950,675 to C. J. Weber et al. discloses an electrical and electronic circuit offering protection to motors, compressors and the like, from conditions of low energizing voltage or momentary voltage interruptions resulting in excessive mechanical load (locked rotor). When the undesirable condition is present, an internal relay prevents the equipment from being energized—transient conditions being allowed for by means of suitable time delay circuitry. The protection device provides significant improvement in safety and economy by preventing equipment from burning up.

U.S. Pat. No. 4,038,061 to R. M. Anderson et al. discloses a control system for a central air conditioner. The air conditioner includes an outdoor condensing unit including a refrigerant compressor, an indoor evaporator unit, an indoor thermostat responsive to the indoor temperature for controlling the air conditioner, and a control system for protecting the air conditioner and indicating to the user certain malfunctions in the air conditioner should they occur. The malfunction indication may be by means of signal lights and a manually operable reset control is provided permitting the user to reset the control system. The malfunction indicator and reset control are disposed adjacent the thermostat for facilitated determination of the system operating condition. The control system includes an improved control position for starting of the compressor motor which is arranged to prevent operation of the system in the event of a low power supply voltage condition. The control system provides a minimum “Off” reset time before permitting the air conditioner to automatically attempt to restart regardless of the condition causing stopping of the air conditioner. The control system further includes a current sensing control that determines the compressor motor current a preselected time after the closing of the compressor motor switch and is arranged to discontinue operation of the compressor motor in the event the current is above a preselected high value. Clock pulses are used to facilitate operation of the current sensing control. Improved accuracy in the timing of the control system is obtained by means of coordinated use of clock pulses and R-C time delays.

U.S. Pat. No. 4,122,413 to C. L. Chen discloses a series resistor-capacitor combination coupled across a source of supply potential so that the capacitor will charge toward the supply potential through the resistor. The capacitor is discharged through a shunt connected switch that is operated by means of a latch. A pair of inverters coupled to the capacitor respond to the capacitor charge and operate through logic means to set and reset the latch. The inverters are made to have similar but different thresholds. When the capacitor charge is below both thresholds, the latch is set to turn the switch off so that the capacitor charges. When both thresholds are exceeded, the logic resets the latch to turn the switch on and discharge the capacitor. The capacitor is charged and is discharged between the two thresholds that are substantially independent of circuit fabrication variables.

U.S. Pat. No. 4,281,358 to L. A. Plouffe discloses a protection system for a dynamoelectric machine providing a plurality of protective functions comprising a module having as a first function over temperature protection including thermal sensors adapted to be placed in heat transfer relation with the windings of the machine. The sensors are connected to a sensing circuit provided with shorted sensor protection. When connected in parallel a channel is provided for each sensor and is isolated from one another. Other functions include a minimum off delay timer which prevents rapid cycling of the machine. An oil pressure timer particularly useful with a compressor motor to sense oil pressure between the output of the oil pump and the crankcase in order to deenergize the motor should there be inadequate oil pressure for a selected period of time, a low voltage cut out network in the event of the occurrence of low voltage conditions, and a circuit to facilitate use of controls in the output side of the system if desired while permitting operation of the system only on the condition of output current flow. The minimum off delay timer can be modified to provide a manual reset circuit which will lock out or prevent energization of the machine each time the protection circuit is tripped. Reset can be accomplished only by removing power to the module and reapplying said power.

U.S. Pat. No. 4,415,943 to D. W. Wortman discloses an equipment protector and energy saving apparatus including transient protection as well as under voltage protection by preventing the reduced voltage from being applied to motors and other apparatuses that may be damaged because of insufficient voltage being applied thereto. Provision is incorporated to protect for momentary low voltage transients and turn-on prevention, if the line voltage should be reduced below a predetermined value. Provision is also made for correcting for a small increase in line voltage which may occur when the operating equipment is removed from the line. A timing device may be incorporated therein in order to remove the protected equipment from the line for predetermined intervals of time.

U.S. Pat. No. 4,502,287 to H. L. Hare et al. discloses a refrigeration system alarm device including a temperature monitoring circuit that detects when a temperature within the refrigeration system exceeds a preselectable temperature reference level. The device also includes an alternating current power monitor circuit that detects when any one of a plurality of alternating current power inputs is interrupted. The device also includes a direct current power monitor circuit that includes a battery and a comparator circuit for determining when the voltage of the battery is below a predetermined level. When an excessive temperature is detected or an alternating current power input interruption is detected or the battery voltage is below the predetermined reference level, a visual or audible alarm signal is generated. If an alternating current power input interruption is detected, a control signal generated in response thereto controls a compressor control circuit to prevent a compressor of the refrigeration system from operating during the alternating current power interruption and a predetermined time period thereafter.

U.S. Pat. No. 4,543,527 to R. P. Schuchmann et al. discloses a new and improved method and apparatus for detecting a target location with respect to an inductive tank circuit. A sensing field such as an electromagnetic field is established having an amplitude which changes in value due to the presence of a target in the sensing field. A first energy level is provided to maintain the field at an amplitude. A second energy level is provided to achieve a value for the field within the predetermined amount of time after initiation of the field.

U.S. Pat. No. 4,584,623 to E. Bello et al. discloses an electronic circuit for sensing over-voltage and under-voltage within narrow threshold limits, and voltage interruption, in the energization circuit of a sensitive load, such as a refrigeration compressor motor load, to protect against overheating damage and burn-out. Setting to a nominal operating line voltage is provided for to obviate readjustment to the threshold voltages of a window comparator utilized to sense over-voltage and under-voltage.

U.S. Pat. No. 5,455,469 to C. B. Ward discloses a delay-on-break circuit adaptable for A.C. or D.C. applications utilizing a timer and a pair of comparators to prevent a load from being re-energized until at least a predetermined period of time has elapsed since the most recent deenergization of the load. A feedback element, such as a zener diode, connected between the output of one of the comparators and a feedback input thereof provides reliable latching of the load through zero crossings of the line in A.C. applications without use of a latching capacitor while simultaneously providing brownout protection capable of rapidly deenergizing the load in the event of an undesired decrease in line voltage.

Therefore, it is an object of the present invention to provide an improved apparatus for controlling an interconnect switch connecting a power source to a load that is suitable for disconnecting electrical power to the load after an interruption and/or reduction of voltage of the power source.

Another object of this invention is to provide an improved apparatus for controlling an interconnect switch connecting a power source to a load that is suitable for use with air conditioning systems and other electrical systems sensitive to interruption and/or reduction of voltage of the power source.

Another object of this invention is to provide an improved apparatus for controlling an interconnect switch connecting a power source to a load incorporating a regenerative feedback system for decreasing the time for the apparatus to respond to an interruption and/or reduction of voltage of the power source.

Another object of this invention is to provide an improved apparatus for controlling an interconnect switch connecting a power source to a load that is cost effective, efficient and reliable.

The foregoing has outlined some of the more pertinent objects of the present invention. These objects should be construed as being merely illustrative of some of the more prominent features and applications of the invention. Many other beneficial results can be obtained by modifying the invention within the scope of the invention. Accordingly other objects in a full understanding of the invention may be had by referring to the summary of the invention and the detailed description describing the preferred embodiment of the invention.

### SUMMARY OF THE INVENTION

A specific embodiment of the present invention is shown in the attached drawings. For the purpose of summarizing the invention, the invention relates to an improved apparatus for controlling an interconnect switch connecting a power source to a load. The apparatus comprises an interconnect switch control circuit connected to the interconnect switch for closing the interconnect switch upon an application of voltage from the power source. A voltage storage circuit stores a voltage related to a nominal operating voltage of the power source. A voltage sensing circuit senses an instantaneous voltage of the power source. A comparator is connected to the voltage storage circuit and the voltage sensing circuit for comparing the instantaneous voltage of the power source relative to the nominal operating voltage of the power source. A timing circuit is connected to the comparator and the interconnect switch control circuit for opening the interconnect switch for a selected period of time after a reduction of the voltage of the power source.

The interconnect switch comprises a primary switch connecting the power source to the load and an input circuit for controlling the conduction status of the primary switch. In one embodiment of the invention, the interconnect switch includes a mechanical relay switch comprising a primary switch having a relay contact and an input circuit having a solenoid coil for controlling the position of the relay contact. In another embodiment of the invention, the interconnect switch includes a solid state relay switch comprising a primary switch connecting the power source to the load and an input circuit for controlling the conduction status of the primary switch.

In a more specific embodiment of the invention, the interconnect switch control circuit comprises a first circuit component for receiving a voltage input and a second circuit component for controlling the interconnect switch. A feedback component provides a positive feedback from the second circuit component to the first circuit component for accelerating the control of the interconnect switch upon an input to the first circuit component.

The interconnect switch control circuit may comprise a first circuit component and a second circuit component. The second circuit component provides a first and a second output for closing and opening the interconnect switch, respectively. A feedback component interconnects the second circuit component to the first circuit component for providing a positive feedback from the second circuit component to the first circuit component for accelerating the first output for rapidly closing the interconnect switch upon an initial input to the first circuit component.

The voltage storage circuit comprises a voltage storage capacitor connected in parallel with a voltage storage zener diode for storing the voltage related to the nominal operating voltage of the power source. The voltage storage circuit charges the voltage storage capacitor to a level equal to a breakdown voltage of the voltage storage zener diode during a nominal operating voltage of the power source.

The comparator circuit is connected to the voltage storage circuit and voltage sensing circuit for providing a comparator output upon a reduction of the instantaneous voltage of the power source relative to the nominal operating voltage of the power source.

The timing circuit comprises a timing capacitor connected in parallel with a timing resistor. The comparator charges the timing capacitor upon a reduction of operating voltage of the power source. The timing capacitor discharges through the resistor for generating the selected period of time for opening the interconnect switch.

The foregoing has outlined rather broadly the more pertinent and important features of the present invention in order that the detailed description that follows may be better understood so that the present contribution to the art can be more fully appreciated. Additional features of the invention will be described hereinafter which form the subject matter of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention.

### BRIEF DESCRIPTION OF THE DRAWINGS

For a fuller understanding of the nature and objects of the invention, reference should be made to the following detailed description taken in connection with the accompanying drawings in which:

FIG. 1 is a block diagram of an apparatus incorporating the present invention for operating n interconnect switch connected between a power source and a load;

FIG. 2 is a circuit diagram of the apparatus of FIG. 1;

FIG. 3 is a circuit diagram similar to FIG. 2 with a conventional power switch shown in a closed position for closing an interconnect switch;

FIG. 4 is a circuit diagram similar to FIG. 3 with a conventional power switch shown in a closed position and with the voltage of the power source being reduced from the normal operating level and with the interconnect switch being shown in an open position; and

FIG. 5 is a circuit diagram similar to FIG. 4 with a conventional power switch shown in a closed position and with the voltage of the power source being returned to the normal operating level and with the interconnect switch still being shown in an open position.

Similar reference characters refer to similar parts throughout the several Figures of the drawings.

### DETAILED DISCUSSION

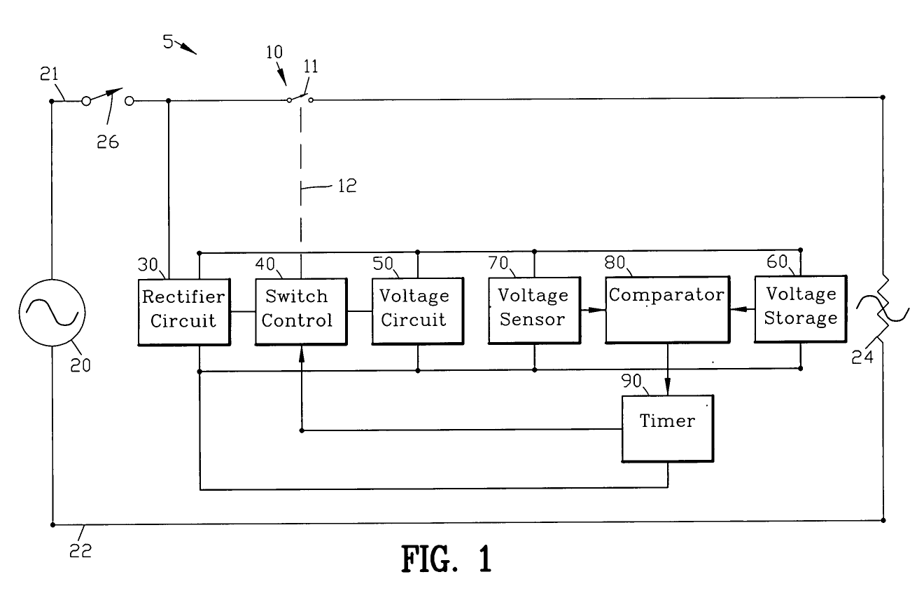

FIG. 1 is a block diagram incorporating an apparatus 5 for operating an interconnect switch 10 connected between a power source 20 and a load 24. The power source 20 is connected to the load 24 by power connectors 21 and 22. The interconnect switch 10 is located within the power connector 21. A conventional power switch 26 is interposed within the power connector 21.

In this example, the power source 20 is shown as an alternating current power source 20. The power source 20 may be representative of a single or multi-phase alternating current power source.

The load 24 may be representative and virtually any type of load. Preferably, the load 24 is representative of a load 24 that is sensitive to rapid disconnection and reconnection of the power source 20 and/or is sensitive to a reduction in power output of the power source 20. An air-conditioning unit is one example of a load 24 that is a sensitive to rapid disconnection and reconnection of the power source 20 and/or is sensitive to a reduction in power output of the power source 20. It is well known in the art that a rapid disconnection and reconnection of the power source 20 to an air-conditioning unit may cause of damage to the air-conditioning compressor due to internal pressures within the air-conditioning compressor.

The interconnect switch 10 is shown schematically having a primary switch 11 and an input circuit 12. The input circuit 12 is used for actuating the primary switch 11 between an open and a close position.

The apparatus 5 includes a rectifier circuit 30 connected across the power connectors 21 and 22. The rectifier circuit 30 provides direct current electrical power to the apparatus 5. The apparatus 5 comprises a switch control circuit 40 having a voltage bias circuit 50. The switch control circuit 40 is connected to the input circuit 12 of the interconnect switch 10 for controlling the operation thereof.

A voltage storage circuit 60 and a voltage sensor circuit 70 provide outputs to a comparator 80. The comparator 80 compares a normal operating voltage from the voltage storage circuit 60 to an instantaneous voltage from the voltage sensor circuit 70. The comparator 80 provides a signal to a timing circuit 90 upon the comparator 80 sensing an interruption and/or reduction of voltage.

The timing circuit 90 is connected to the switch control circuit 40 for opening the interconnect switch 10 for a selected period of time upon the comparator 80 sensing an interruption and/or reduction of voltage. The timing circuit 90 insures the switch control circuit 40 maintains the interconnect switch 10 in an open condition for a selected period of time sufficient to prevent damage to the load 24.

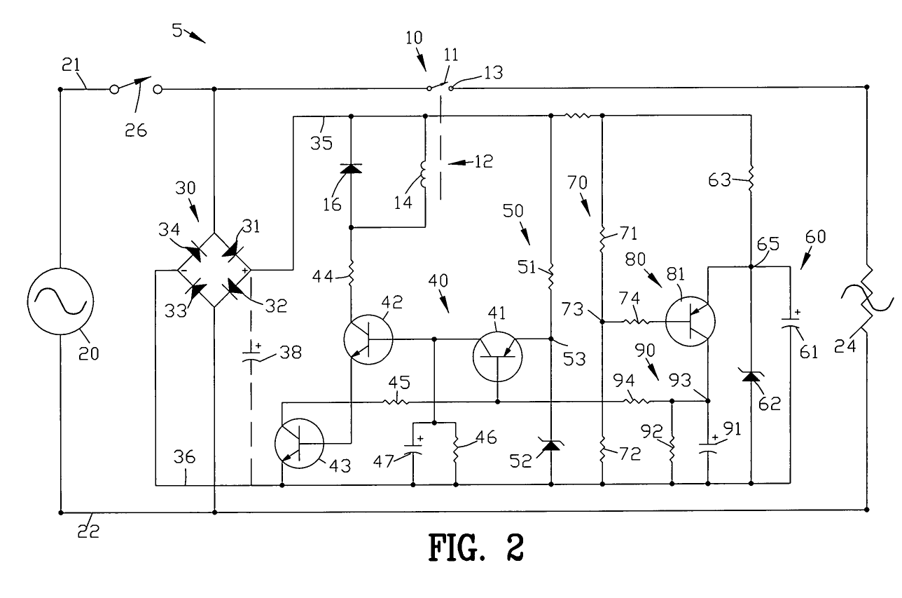

FIG. 2 is a circuit diagram of the apparatus of FIG. 1. The interconnect switch 10 may be a representative of a mechanical relay having relay contacts 13 as a primary switch 11 and a solenoid coil 14 as the input circuit 12. A diode 16 is connected across the solenoid coil 14 for inhibiting resonance within the input circuit 12. In another example, the interconnect switch 10 may be representative of a solid-state switch.

The rectifier circuit 30 is shown as a full wave bridge comprising diodes 31-34. The direct current output of the rectifier circuit 30 is provided on positive and negative connectors 35 and 36. An optional filter capacitor 38 may be connected between the positive and negative connectors 35 and 36 for filtering the direct current output from the rectifier circuit 30.

The switch control circuit 40 comprises transistors 41-43. The switch control circuit 40 is connected to the input circuit 12 for controlling the interconnect switch 10. Transistor 41 of the switch control circuit 40 is connected to the voltage bias circuit 50.

The voltage bias circuit 50 is shown as a voltage divider connected between the positive and negative connectors 35 and 36 of the rectifier circuit 30. The voltage divider comprises resistor 51 and zener diode 52. The emitter of transistor 41 is connected to the intersection 53 of resistor 51 and zener diode 52. The collector of transistor 41 is connected to the base of transistor 42. The emitter of transistor 42 is connected to the base of transistor 42.

The collector of transistor 42 is connected through resistor 44 to the input circuit 12 of the interconnect switch 10. The collector of transistor 43 is fed back through resister 45 to the base of transistor 41. A filter circuit comprising comprises a resistor 46 and a capacitor 47 is connected between transistors 41 and 42 and the negative connector 36.

The voltage storage circuit 60 including a capacitor 61 and a zener diode 62 are connected in parallel. The voltage storage circuit 60 is connected in series with a resistor 63 across the positive and negative connectors 35 and 36 of the rectifier circuit 30. The voltage storage circuit 60 and the resistor 63 define an interconnection 65.

The voltage sensing circuit 70 comprises series resistors 71 and 72 connected as a voltage divider across the positive and negative connectors 35 and 36 of the rectifier circuit 30. The series resistors 71 and 72 define an interconnection 73.

The voltage storage circuit 60 and the voltage sensing circuit 70 are connected to a comparator 80 shown as a transistor 81. The interconnection 65 of the voltage storage circuit 60 is connected to the emitter of transistor 81. The interconnection 73 of the voltage sensing circuit 70 is connected to the base of transistor 81 by a resistor 74.

The timing circuit 90 comprising capacitor 91 and resistor 92 are connected in electrical parallel. The timing circuit 90 defines an interconnection 93 connected to the collector of the transistor 81. The interconnection 93 is connected through resistor 94 to the base of transistor 41.

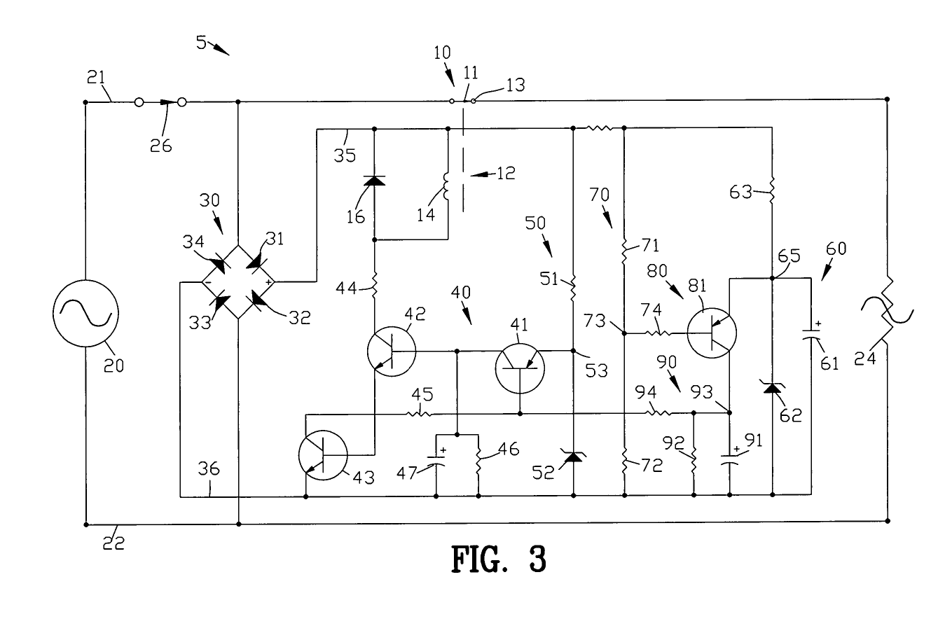

FIG. 3 is a circuit diagram similar to FIG. 2 with the conventional power switch 26 moved into the closed position to apply normal electrical power as illustrated by the normal amplitude of the sine wave. The normal electrical power is applied from the power source 20 along power conductors 21 and 22 to the rectifier circuit 30. Electrical current flows from the power conductors 21 and 22 into the rectifier circuit 30 to provide a positive voltage on the positive conductor 35 and a negative voltage on the negative conductor 36. The interconnect switch 10 is initially in the open position as shown in FIG. 2.

Conventional current flows from the positive conductor 35 thorough the voltage bias circuit 50 comprising the resistor 51 into the emitter-base circuit of transistor 41. The zener diode 52 clamps the voltage of the emitter of the transistor 41 relative to the voltage on the negative conductor 36 in accordance with the breakdown voltage of the zener diode 52. The value of the resistor 51 and the breakdown voltage of the zener diode 52 are selected to enable conduction of transistor 41 when the base of transistor 41 is at a voltage near the negative conductor 36. The conventional current flows from the emitter-base circuit of transistor 41 through resistor 94 and 92 to the negative conductor 36.

The emitter-base current of transistor 41 enables conduction of an emitter-collector current of transistor 41. The emitter-collector current of transistor 41 enables a base emitter current in transistor 42 and 43 to cause conduction of transistor 42 and 43. The resistor 46 and the capacitor 47 provide a filtering between the collector of transistor 41 and the base of transistor 42.

The conduction of transistors 42 and 43 provides a current flow through the input circuit 12 of the interconnect switch 10. More specifically, current flows from the positive conductor 35 thorough the solenoid coil 14, the resistor 44 and transistors 42 and to operate the interconnect switch 10 from the normally open position to a closed position. In this embodiment, resistor 44 is interposed in the collector circuit of transistor 42 to function as a current limiting resistor. However, the use of resistor 44 may be eliminated depending upon the impedance of the selection of the solenoid coil 14 in the input circuit 12 of the interconnect switch 10.

The collector of transistor 43 is connected through the resistor 45 to the base of transistor 41 to provide a feedback circuit. The resistor 45 is selected to be a lower value than the resistors 94 and 92. The conduction of the transistor 43 further reduces the voltage at the base of transistor 41 to increase further the conduction of transistor 41 and accordingly to increase the conduction of transistors 42 and 43. The feedback circuit between the collector of transistor 43 and the base of transistor 41 causes a very fast acting conduction of the transistors 41, 42 and 43 of the switch control circuit 40. Accordingly, the interconnect switch 10 is moved substantially instantaneously from the normally open position to a closed position.

Concomitantly with the operation of switch control circuit 40, conventional current flows through into the voltage storage circuit 60 comprising the capacitor 61 and zener diode 62. The conventional current flows from the positive conductor 35 through resistor 63 to charge capacitor 61 to a voltage commensurate with the breakdown voltage of the zener diode 62. The voltage on capacitor 61 is applied to circuit interconnection 65.

During a normal operating voltage of the power source 20, the voltage storage circuit 60 comprising the capacitor 61 and zener diode 62 maintains a voltage related to the normal operating voltage of the power source 20. For example, the zener diode 62 may have a breakdown voltage of 40 volts thereby enabling capacitor 61 to charge to a level of 40 volts.

The voltage sensing circuit 70 comprises the resistors 71 and 72 connected between the positive and negative conductors 35 and 36. The sensed voltage at interconnection 73 is applied to the comparator 80 comprising transistor 81. The sensed voltage at the interconnection 73 is applied through resistor 74 to the base of transistor 81. The breakdown voltage of the zener diode 62 and the values of the resistors 71 and 72 are selected to inhibit conduction of transistor 81 during normal operating voltage of the power source 20.

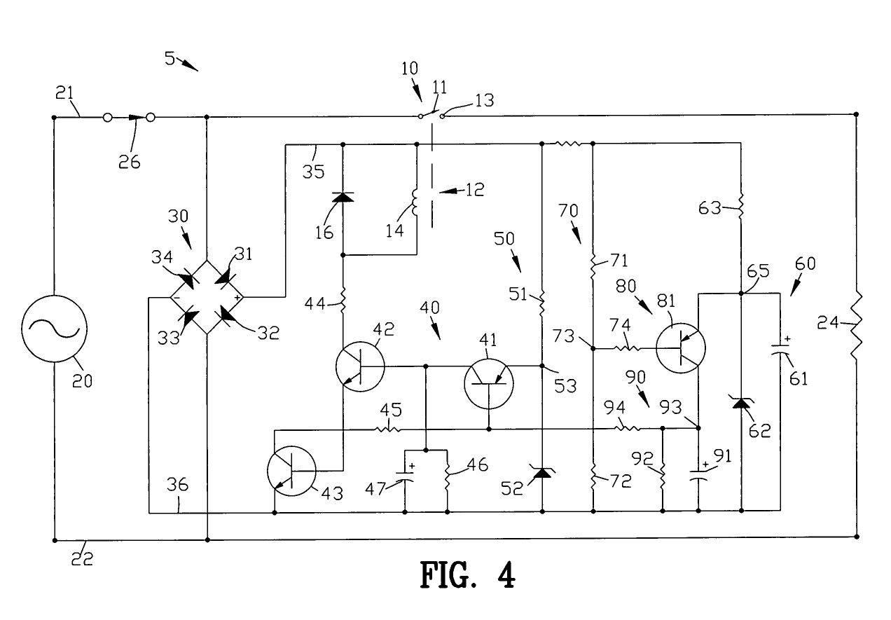

FIG. 4 is a circuit diagram similar to FIG. 3 with the voltage of the power source 20 reduced from the normal operating level as illustrated by the reduced amplitude of the sine wave. Upon a reduction of the voltage of the power source 20, the voltage at interconnection 73 of the voltage sensing circuit 70 is reduced in accordance with the reduction of the voltage of the power source 20. The reduced voltage at interconnection 73 is applied to the base of transistor 81. The voltage at interconnection 65 of the voltage storage circuit 60 remains constant by virtue of the charge on the storage capacitor 61. The voltage at interconnection 65 of the voltage storage circuit 60 is applied to the emitter of transistor 81. The reduced voltage at the base of transistor 81 in combination with the constant voltage at the emitter of transistor 81 enables conduction of transistor 81.

The timing circuit 90 comprising capacitor 91 and resistor 92 is connected to the collector of transistor 81. The conduction of transistor 81 charges capacitor 91 and increases the positive voltage at interconnection 93 of the timing circuit 90. The increased positive voltage of the timing circuit 90 is applied to the switch control circuit 40.

The increased positive voltage at interconnection 93 of the timing circuit 90 is applied to the base of the transistor 41 of the switch control circuit 40. The zener diode 52 clamps the voltage of the emitter of the transistor 41 relative to the voltage on the negative conductor 36. The increased positive voltage applied to the base of the transistor 41 in combination with the clamped voltage at the emitter of the transistor 41 terminates conduction of the transistor 41. The termination of the conduction of the transistor 41 terminates conduction of the transistors 42 and 43. The termination of the transistors 42 and 43 terminates current flow through the solenoid coil 14 of the input circuit 12 of the interconnect switch 10. The termination of the current flow through the solenoid coil 14 of the input circuit 12 of the interconnect switch 10 returns the primary switch 11 to the normally open position. The opening of the interconnect switch 10 terminates electrical power to the load 24.

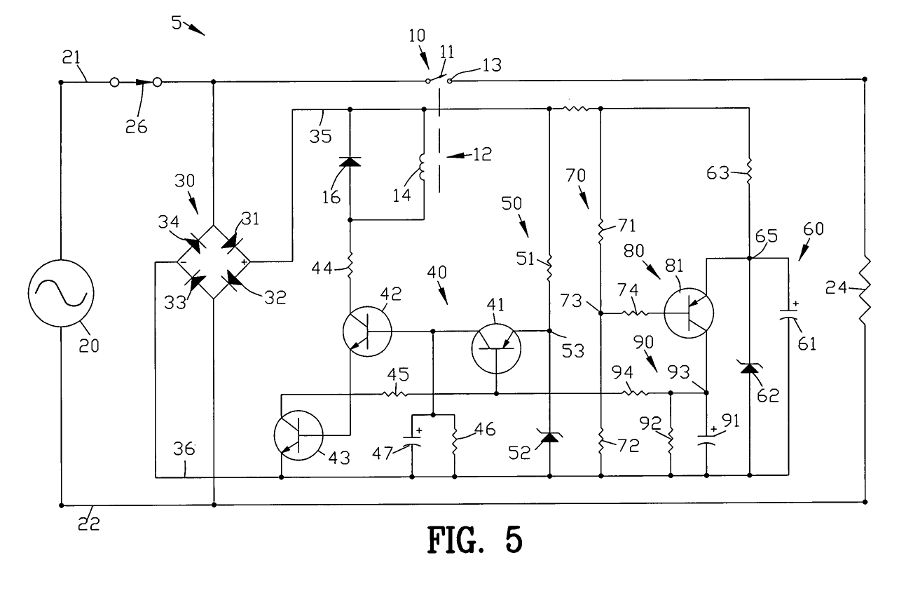

FIG. 5 is a circuit diagram similar to FIG. 4 with the voltage of the power source 20 returned to the normal operating level as illustrated by the normal amplitude of the sine wave. The voltage at the interconnection 93 of the timing circuit 90 maintains transistors 41-43 in a non-conduction condition to maintain the interconnect switch 10 in an open position.

As the charge on capacitor 91 discharges through resistor 92 of the timing circuit 90, the voltage at the interconnection 93 is reduced in accordance with the RC time constant of the timing circuit 90. Preferably, the RC time constant of the timing circuit 90 is selected to maintain the transistors 41-43 in a non-conduction condition for a period of four to six minutes.

After the duration of four to six minutes, the voltage at the interconnection 93 is reduced to a level to enable conduction of the transistor 41. The conduction of transistor 41 causes conduction of the transistors 42 and 43 in a manner set forth previously with reference to FIG. 2. The conduction of the transistors 42 and 43 closes the interconnect switch 10 to reapply electric power from the power source 20 to the load 24 after the period of four to six minutes.

The present invention provides an improved apparatus for controlling an interconnect switch for connecting a power source to a load that is suitable for disconnecting electrical power to the load after an interruption and/or reduction of voltage of the power source. The invention is suitable for use with air conditioning systems and other electrical systems sensitive to interruption and/or reduction of voltage of the power source. The improved apparatus incorporates a regenerative feedback system for decreasing the time for the apparatus to respond to an interruption and/or reduction of voltage of the power source.

Although the invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. An apparatus for controlling an interconnect switch connecting a power source to a load; comprising:
an interconnect switch control circuit connected to the interconnect switch for closing the interconnect switch upon an application of voltage from the power source;
a voltage storage circuit for storing a nominal operating voltage;
a comparator connected to said voltage storage circuit for comparing an instantaneous voltage relative to said nominal operating voltage; and
a timing circuit connected to said comparator and said interconnect switch control circuit for opening said interconnect switch for a selected period of time after a reduction of said instantaneous voltage.

2. An apparatus for controlling an interconnect switch as set forth in claim 1, wherein the interconnect switch includes a mechanical relay switch comprising a primary switch having relay contacts and an input circuit having a solenoid coil for controlling a relative position of said relay contacts.

3. An apparatus for controlling an interconnect switch as set forth in claim 1, wherein the interconnect switch includes a solid state relay switch comprising a primary switch connecting the power source to the load and an input circuit for controlling the conduction of said primary switch.

4. An apparatus for controlling an interconnect switch as set forth in claim 1, wherein said interconnect switch control circuit comprises a first circuit component for receiving a voltage input and a second circuit component for controlling said interconnect switch; and
a feedback component for providing a positive feedback from said second circuit component to said first circuit component for accelerating said closing of said interconnect switch upon an input to said first circuit component.

5. An apparatus for controlling an interconnect switch as set forth in claim 1, including a voltage bias circuit for biasing an input of said interconnect switch control circuit; and
said voltage bias circuit including a clamping zener diode for clamping said input of said interconnect switch control circuit to a supply voltage.

6. An apparatus for controlling an interconnect switch as set forth in claim 1, wherein said voltage storage circuit comprises a voltage storage capacitor connected in parallel with a voltage storage zener diode for storing said voltage related to said nominal operating voltage of the power source.

7. An apparatus for controlling an interconnect switch as set forth in claim 1, wherein said voltage sensing circuit comprises a voltage divider connected for sensing said voltage related to said instantaneous voltage of the power source.

8. An apparatus for controlling an interconnect switch as set forth in claim 1, including a rectifier circuit connected to the power source for providing an operating voltage to said circuits; and
said rectifier circuit providing an input to said voltage sensing circuit for sensing said voltage related to said instantaneous voltage of the power source.

9. An apparatus for controlling an interconnect switch as set forth in claim 1, wherein said comparator circuit is connected to said voltage storage circuit and voltage sensing circuit for providing a comparator output upon a reduction of said instantaneous voltage of the power source.

10. An apparatus for controlling an interconnect switch as set forth in claim 1, wherein said timing circuit comprises a timing capacitor connected in parallel with a timing resistor;
said comparator charging said timing capacitor upon a reduction of said instantaneous voltage of the power source; and
said timing capacitor discharging through said resistor for generating said selected period of time for opening the interconnect switch.

11. An apparatus for controlling an interconnect switch connecting a power source to a load; comprising:
an interconnect switch control circuit connected to the interconnect switch for closing the interconnect switch upon an application of voltage from the power source;
a voltage storage circuit for storing a voltage related to a nominal operating voltage of the power source;
a voltage sensing circuit for sensing a voltage related to the instantaneous voltage of the power source;
a comparator connected to said voltage storage circuit and said voltage sensing circuit for comparing said instantaneous voltage relative to said nominal operating voltage; and
a timing circuit connected to said comparator and said interconnect switch control circuit for opening said interconnect switch for a selected period of time after a reduction of the instantaneous voltage relative to the nominal operating voltage of the power source.

12. An apparatus for controlling an interconnect switch as set forth in claim 11, wherein the interconnect switch comprises a primary switch connecting the power source to the load and an input circuit for controlling the conduction of said primary switch.

13. An apparatus for controlling an interconnect switch as set forth in claim 11, wherein the interconnect switch includes a mechanical relay switch comprising a primary switch having relay contacts and an input circuit having a solenoid coil for controlling a relative position of said relay contacts.

14. An apparatus for controlling an interconnect switch as set forth in claim 11, wherein the interconnect switch includes a solid state relay switch comprising a primary switch connecting the power source to the load and an input circuit for controlling the conduction of said primary switch.

15. An apparatus for controlling an interconnect switch as set forth in claim 11, wherein said interconnect switch control circuit comprises a first circuit component for receiving a voltage input and a second circuit component for controlling said interconnect switch; and
a feedback component for providing a positive feedback from said second circuit component to said first circuit component for accelerating said closing of said interconnect switch upon an input to said first circuit component.

16. An apparatus for controlling an interconnect switch as set forth in claim 11, wherein said interconnect switch control circuit comprises a first circuit component and a second circuit component;
said second circuit component providing a first and a second output for closing and opening said interconnect switch, respectively; and
a feedback component interconnecting said second circuit component to said first circuit component for providing a positive feedback from said second circuit component to said first circuit component for accelerating said closing said interconnect switch upon an initial input to said first circuit component.

17. An apparatus for controlling an interconnect switch as set forth in claim 11, including a voltage bias circuit for biasing an input of said interconnect switch control circuit; and
said voltage bias circuit including a clamping zener diode for clamping said input of said interconnect switch control circuit to a supply voltage.

18. An apparatus for controlling an interconnect switch as set forth in claim 11, wherein said voltage storage circuit comprises a voltage storage capacitor connected in parallel with a voltage storage zener diode for storing said voltage related to said nominal operating voltage of the power source.

19. An apparatus for controlling an interconnect switch as set forth in claim 11, wherein said voltage storage circuit comprises a voltage storage capacitor connected in parallel with a voltage storage zener diode; and
said voltage storage capacitor being charged to a level equal to a breakdown voltage of said voltage storage zener diode during a nominal operating voltage of the power source.

20. An apparatus for controlling an interconnect switch as set forth in claim 11, wherein said voltage sensing circuit comprises a voltage divider connected for sensing said voltage related to said instantaneous voltage of the power source.

21. An apparatus for controlling an interconnect switch as set forth in claim 11, including a rectifier circuit connected to the power source for providing an operating voltage to said circuits; and
said rectifier circuit providing an input to said voltage sensing circuit for sensing said voltage related to said instantaneous voltage of the power source.

22. An apparatus for controlling an interconnect switch as set forth in claim 11, wherein said comparator circuit is connected to said voltage storage circuit and voltage sensing circuit for providing a comparator output upon a reduction of said instantaneous voltage of the power source.

23. An apparatus for controlling an interconnect switch as set forth in claim 11, wherein said timing circuit comprises a timing capacitor connected in parallel with a timing resistor;
said comparator charging said timing capacitor upon a reduction of said instantaneous voltage of the power source; and
said timing capacitor discharging through said resistor for generating said selected period of time for opening the interconnect switch.

24. A circuit for controlling opening an interconnect switch connecting a power source and a load upon a reduction of voltage of the power source; comprising:
a rectifier circuit connected to the power source for providing a rectifier voltage related to the voltage of said power source;
a voltage storage circuit connected to said rectifier circuit for storing a voltage related to a nominal operating voltage of the power source;
a voltage sensing circuit connected to said rectifier circuit for sensing a voltage related to an instantaneous voltage the power source;
a comparator circuit connected to said a voltage storage circuit and said voltage sensing circuit for comparing said instantaneous voltage relative to said nominal operating voltage;
a timing circuit connected to said comparator circuit for providing a delayed output for a selected period of time upon said comparator circuit sensing reduction of the said instantaneous voltage relative to said nominal operating voltage; and
an interconnect switch control circuit connecting to said timing circuit and said interconnect switch for opening the interconnect switch for said selected period of time upon said comparator circuit sensing reduction of instantaneous voltage.

25. A circuit for controlling opening an interconnect switch connecting an AC power source and a load upon a reduction of voltage of the AC power source; comprising:
a rectifier circuit connected to the AC power source for providing a rectified voltage related to the voltage of said AC power source;
a voltage storage circuit comprising a capacitor and a zener diode connected to said rectifier circuit for storing a DC voltage related to a nominal operating voltage of the AC power source;
a voltage sensing circuit connected to said rectifier circuit for sensing a rectified voltage related to the instantaneous voltage of the AC power source;
a comparator circuit connected to said a voltage storage circuit and said voltage sensing circuit for comparing said instantaneous voltage relative to said nominal operating voltage for sensing a reduction of in the instantaneous voltage of the AC power source;
a timing circuit connected to said comparator circuit for providing a delayed output for a selected period of time upon said comparator circuit sensing reduction of the said instantaneous voltage relative to said nominal operating voltage; and
an interconnect switch control circuit connecting to said timing circuit and said interconnect switch for opening the interconnect switch for said selected period of time upon said comparator circuit sensing reduction of instantaneous voltage.
